(19) United States
(12) Patent Application Publication
(10) Pub. No.: US 2019/0335735 A1
(43) Pub. Date: Nov. 7, 2019

(54) Outrigger Assembly

(71) Applicant: TACO METALS, INC., Miami, FL (US)

(72) Inventor: Philip J. Serocki, Sparta, TN (US)

(21) Appl. No.: 16/404,280

(22) Filed: May 6, 2019

Related U.S. Application Data
(60) Provisional application No. 62/667,162, filed on May 4, 2018.

(51) Int. Cl. A01K 97/10; F15B 15/06; F15B 21/02

(52) U.S. Cl. CPC A01K 97/10; F15B 15/065; G01D 5/147; F15B 2215/30; F15B 21/02

(57) ABSTRACT

An outrigger mount assembly includes an arm tube configured to receive and hold an outrigger pole. The arm tube is rotationally displaceable in a lifting direction and in a lateral direction. A hydraulic lifting cylinder with a lifting piston is operationally connected to the arm tube for rotating the arm tube in the lifting direction. A rotation tube is operationally connected to the arm tube. A pinion is affixed to the rotation tube opposite the arm tube. A pair of opposing hydraulically driven rack gears drive the pinion and rotate the arm tube via the rotation tube. An electronic controller with a user interface controls the rack gears and the hydraulic lifting piston.

### CROSS-REFERENCE TO RELATED APPLICATION

This application claims the priority, under 35 U.S.C. § 119(e), of provisional application No. 62/667,162 filed May 4, 2018; the prior application is herewith incorporated by reference in its entirety.

### BACKGROUND OF THE INVENTION

### Field of the Invention

Saltwater sport fishing typically consists of anglers positioned on boats that are then dispatched to prolific offshore fishing areas. One useful method of catching gamefish involves a technique known as trolling. Trolling is the practice of baiting hooks that are subsequently lowered and dragged behind the stern of a slow moving vessel by the angler. In order to increase the chances of hooking a fish, it is beneficial to have as many lines in the water as possible. To a gamefish, the wake of a vessel generally creates the appearance of a large school of smaller fish to be preyed upon. The angler can strategically simulate bands of straggling or displaced fish from the school with numerous baited lines. These simulated straggling fish are misinterpreted to be the disadvantaged and weakened fish that gamefish frequently utilize as a food source.

As stated above, an angler will often drag as many baited lines from behind the boat as possible, thereby increasing the chances of hooking a fish. However, as more baited lines are used, the probability of the lines becoming entangled with one another increases. This is a problem that occurs in a variety of situations, such as with a narrow beam boat or any boat that is in the process of being turned. As a result, sport fishing outriggers have been developed to assist in keeping the various lines separated. However, the positioning and lowering of outrigger booms presents additional problems of rotational movement and preventing the booms from contacting the water. This problem has brought forth various attempts to create mechanisms to rotate the boom and that prevent the boom from contacting the water.

Outriggers consist of a long pole, or boom, having one end secured to the boat with deployment resulting from an outward lateral extension of the boom from a side of the boat. Baited fishing lines often have integrated release clips that are attached to the outriggers, thereby providing sufficient separation between the lines to prevent tangling. When a fish is hooked on the bait line, the line clip releases from the outrigger, allowing the angler to reel-in the fish.

Outriggers are required to be freely stowable to a position beside the boat for close quarters operation and docking. For practicality, the outrigger should be swung laterally outward to its deployed position. The prior art includes various types of mounting schemes including outrigger units for horizontal and vertical mounting, on center consoles, flybridges, half towers, tuna towers, radar arches, and/or T-tops. Prior patents disclose a variety of methods for mounting, deploying, and locking such outriggers into place (see e.g. U.S. Pat. Nos. 5,445,102 and 3,724,791), with each having distinct drawbacks. Such drawbacks include overall mechanical complexity; powered operation; non-durable construction; and/or ineffective position adjustment and locking mechanisms that slip and/or wear out.

Although the prior art discloses a vast array of mechanisms and mounting locations for outrigger mounts, the prior art fails to disclose or otherwise teach a simple and durable outrigger system having an effective boom locking mechanism, a boom stop that prevents excessive lowering, and a positionable arm that allows for both vertical and rotational movement of the boom. This is of particular importance with respect to the excessive forces experienced by an outrigger mount during operation. Both wind and movement (of the boat) impart forces on to a boom, thereby increasing the stresses on the outrigger mount of the boom. Generally, the longer the boom, the greater the stresses at the outrigger mount. If the position adjustment and/or locking mechanism were to succumb to these increases in stress, the outrigger might swing in an unrestricted manner during a critical maneuver or operation, with potentially disastrous or life-threatening results to passengers of the outrigger equipped boat or other surrounding vessels. Accordingly, an outrigger assembly with a novel position adjustment and locking mechanism is disclosed that alleviates this and other shortcomings of the prior art.

As described in the aforementioned prior art, the mounting and operation of a conventional outrigger system can be complicated. Booms of considerable length must be stored in a horizontal position to allow the vessel to pass beneath low bridges, as well as for close quarters maneuvering. Similarly, should the boat pass under or through an object that limits clearance, the boom must be vertically lowered and/or rotated in from the extended position on a non-vertical plane. Preferably the outrigger mount not only rotates in the non-vertical plane in a 360° arrangement from a position on the vessel, but also allows the boom attachment arm to be easily raised and lowered in a vertical plane. Thus, in the operation of a one way of several conventional outrigger booms, the boom is inserted into a vertically adjustable boom attachment arm, usually as part of an elbow, and locked into position with a locking pull pin. The outrigger boom is then rotated in a non-vertical plane to a point determined by the user. Additionally, either before or after the boom is rotated in the non-vertical plane, the user may raise or lower the boom within a vertical plane with respect to the outrigger mount.

Accordingly, what is lacking is an outrigger assembly having an effective boom locking mechanism, a boom stop that prevents excessive lowering, and a positionable arm that allows for both vertical and rotational movement of the boom to eliminate the complicated and problematic outrigger mounts commonly used to support outrigger booms. It allows full operation from the boats control panel.

### SUMMARY OF THE INVENTION

It is accordingly an object of the invention to provide an outrigger mount assembly includes an arm tube configured to receive and hold an outrigger pole. The arm tube is rotationally displaceable in a lifting direction and in a lateral direction. A hydraulic lifting cylinder with a lifting piston is operationally connected to the arm tube for rotating the arm tube in the lifting direction. A rotation tube is operationally connected to the arm tube. A pinion is affixed to the rotation tube opposite the arm tube. A pair of opposing hydraulically driven rack gears drive the pinion and rotate the arm tube via the rotation tube. An electronic controller with a user interface controls the rack gears and the hydraulic lifting piston.

With the foregoing and other objects in view there is provided, a rotation tube bearing, the rotation tube being disposed in the rotation tube bearing and the lifting cylinder being disposed inside of the rotation tube.

In accordance with another feature of the invention, an arm tube has a mount tube to affix the arm tube to the rotation tube, the mount tube has a radially extending flange with a cylindrical portion defining a lifting axis about which the arm tube is rotated when displaced in the lifting direction.

In accordance with an added feature of the invention, a position indicator wheel is disposed in the cylindrical portion, the position indicator wheel being affixed to the arm tube for rotation with the arm tube when the arm tube is rotated in the lifting direction.

In accordance with an additional feature of the invention is a Hall-effect sensor, the position indicator wheel has an insert with respective magnet patterns of magnets for each selectable angular position of the arm tube, the Hall-effect sensor being disposed for detecting a magnet pattern of a user selected angular position of the arm tube and controlling the lifting piston.

In accordance with yet an additional feature of the invention the rack gears each have a respective rack cylinder formed therein that extend in a longitudinal direction thereof.

In accordance with yet another added feature of the invention, each rack cylinder has a corresponding tubular rack piston disposed therein, the rack piston has a conduit formed therein, the conduit opening into the rack cylinder to supply hydraulic fluid to the rack cylinder to actuate the rack cylinder and rotate the pinion.

In accordance with still another added feature of the invention, a pump is fluidically connected to each rack piston for supplying hydraulic fluid to each rack piston.

In accordance with yet still another added feature of the invention, is a method of operating an outrigger mount with an arm tube for deploying an outrigger pole disposed in the arm tube, and providing a mount with an arm tube being rotationally displaceable in a lifting direction and in a lateral direction of a vessel, providing a user interface for user control of the mount, hydraulically raising a lifting piston connected to the arm tube for rotating the arm tube in the lifting direction according to a user selected angular position of the arm tube on the user interface, and hydraulically rotating a rotation tube operationally connected to the arm tube according to user actuation of a rotation switch by controlling a pair of opposing hydraulically driven rack gears rotating a pinion operatively connected to the rotation tube.

The present invention eliminates the manual operation of an outrigger assembly by use an electro-hydraulic system using hydraulics in conjunction with electronic sensors. Providing an outrigger assembly having a positionable arm that allows for both vertical and rotational movement. In accordance with the present invention, there is provided an outrigger assembly. The outrigger assembly includes a boom attachment arm, having a distal end and a proximal end portion, a rotating arm having a distal head portion capable of being adjusted via a hydraulic cylinder and link at the distal head portion to the proximal end portion. A gear operatively engaged to the rotating arm, and is hydraulically operated via a rack and pinion system.

The present invention is further directed to a method for adjusting a boom. The method includes the steps of inserting a boom into an outrigger assembly, securing the boom with twist lock operation, rotationally positioning the boom within a first plane, rotationally positioning the boom within a second plane, and wherein the first plane and the second plane are perpendicular to one another.

Accordingly, it is an objective of the present invention to disclose a sport fishing outrigger assembly that is capable of rotation in a first plane and rotation in a second plane.

Other features which are considered as characteristic for the invention are set forth in the appended claims.

Although the invention is illustrated and described herein as embodied in the outrigger assembly, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

Other features which are considered as characteristic for the invention are set forth in the appended claims.

Although the invention is illustrated and described herein as embodied in an outrigger Assembly, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an exploded view of an arm tube assembly of the according to the invention;

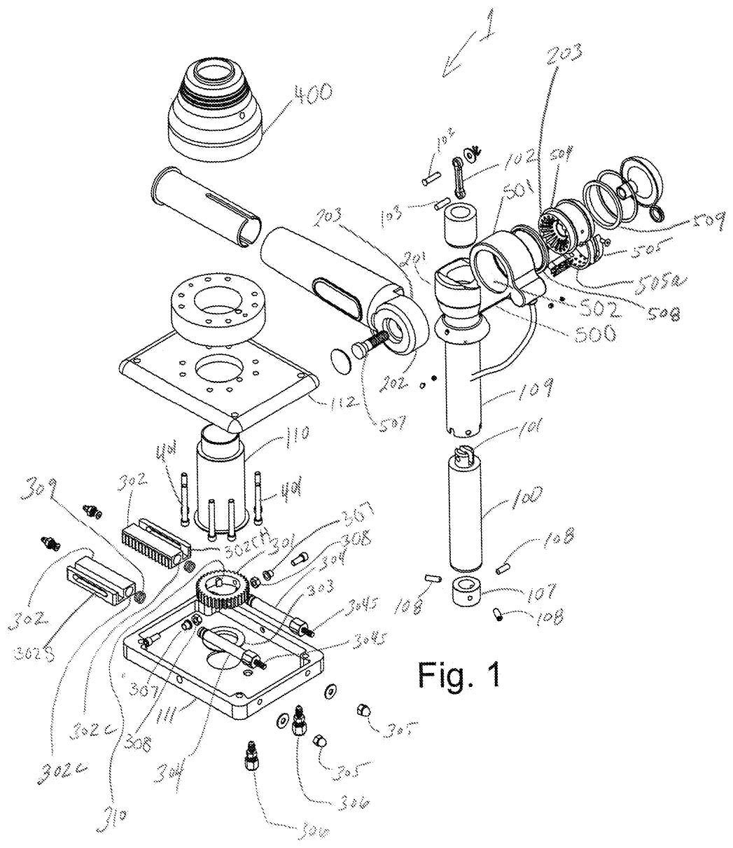

FIG. 2 is a side view of the arm tube assembly;

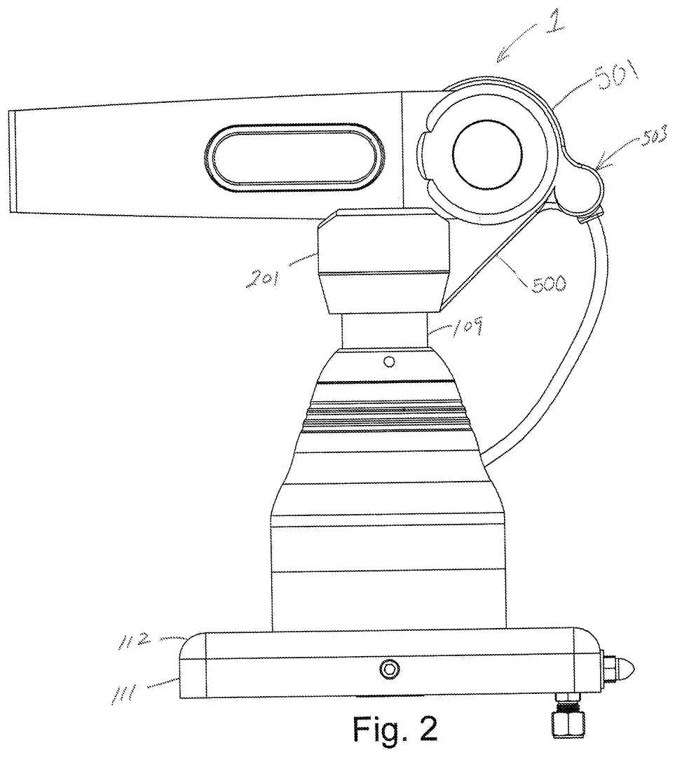

FIG. 3 is a section view taken through the rotation tube along the arm tube of the arm tube assembly;

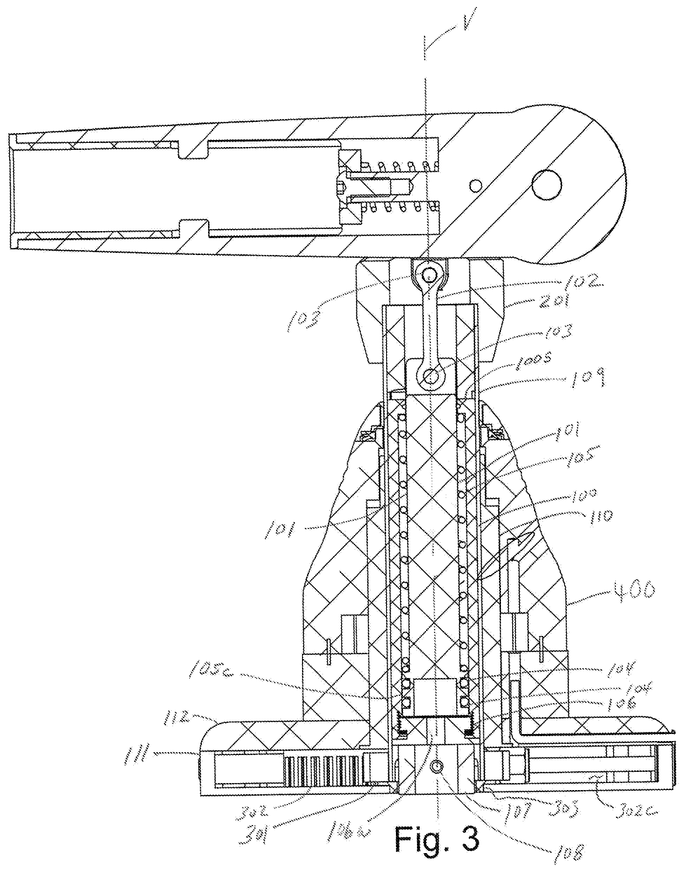

FIG. 4 is a section view taken through the rotation tube perpendicular to the arm tube of the arm tube assembly;

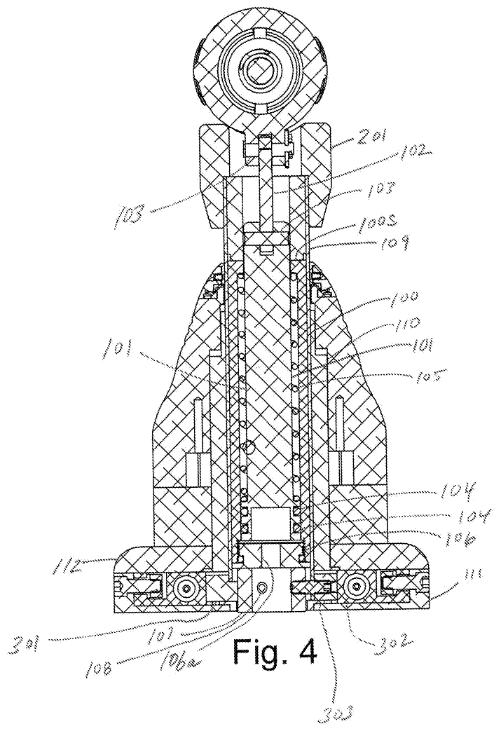

FIG. 5 is a section view taken through the arm tube along the axis thereof;

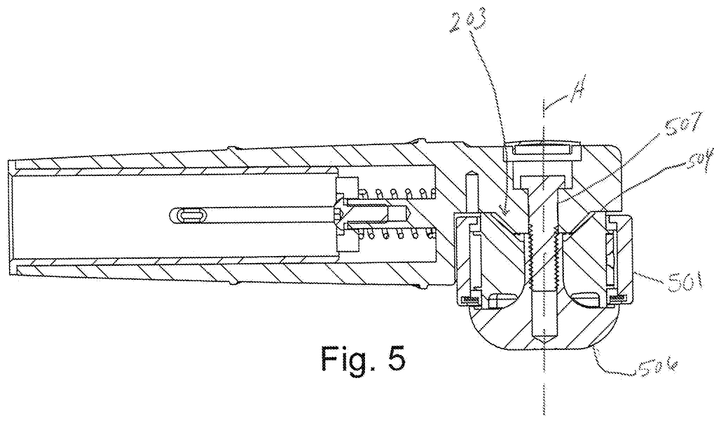

FIG. 6 is a view of a rotation drive portion of the arm tube assembly;

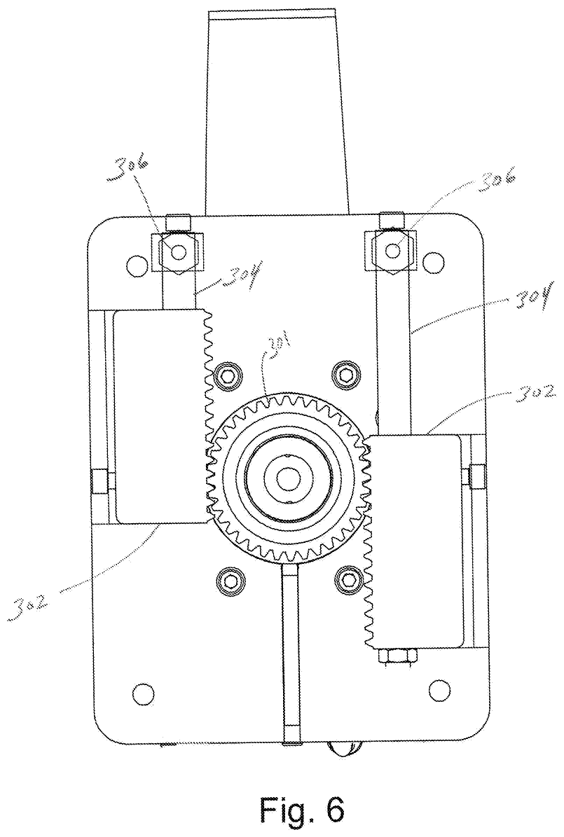

FIG. 7 is a schematic plumbing diagram;

FIG. 8 is a schematic wiring diagram;

FIG. 9 is a front view of a controller showing a user interface;

FIG. 10 is a perspective view of a manifold of the mount assembly;

FIG. 11 is a schematic plumbing view showing a storage position including a controller interface with a different layout than FIG. 9;

FIG. 12 is a schematic plumbing view showing outboard rotation of starboard arm tube including a controller interface of FIG. 11; and

FIG. 13 is a schematic plumbing view showing lifting of starboard arm tube including a controller interface of FIG. 11;

### DESCRIPTION OF THE INVENTION

The present invention pertains to an outrigger mount assembly 1a that has two mounts 1 (starboard and port) each with an arm tube 2 that receives an outrigger pole 3 therein. The arm tube 2 is rotatable independently about a vertical axis V (to deploy the outrigger pole 3 away from the hull of the vessel over the water) and a horizontal axis H (to raise/lift and lower the outrigger arm and set an angle of inclination of the outrigger pole 3 relative to the deck of the vessel). Both of the rotations are hydraulically driven and the construction for carrying out the movements is discussed below.

The raising and lowering is achieved by a hydraulic lifting cylinder 100 that is driven by hydraulic fluid. The cylinder 100 has a piston 101 disposed therein. A first end of the piston 101 has a slot formed therein which receives a lifting link 102 therein. The lifting link 102 is has a pin 103 that fixes an end of the lifting link 102 to the piston 101. A second end of the lifting link 102 is pivotably attached to an underside of the outrigger arm tube 2 by a pin 103. When the piston 101 is actuated, the arm tube 2 pivots about the pivot axis H, where the arm tube 2 is rotatably mounted. The piston 101 has a base with a collar 101c that includes annular grooves for sealing rings 104 that seal against inside diameter of cylinder 100. The cylinder 100 includes a shoulder 100s and a return spring 105 is disposed on the outside diameter of the piston 101 in a gap above the collar 101c between the piston 101 and the cylinder 100 and is captured between the shoulder 100s and the collar 101c for assisting displacement of the piston 101 by pressing down on the collar 101c when the arm tube 2 is desired to be lowered and the hydraulic pressure has been released. A base end of the cylinder 100 has a plug 1 that has a threaded connection with the cylinder 100. The plug 106 has an aperture 106a for receiving a fitting that connects to a hydraulic fluid line for supply hydraulic pressure to the cylinder for raising the piston. Below the plug 106, a support ring 107 is provided to hold the cylinder 100 in place. In this regard, the support ring 107 has holes for receiving set screws 108 that pass through a rotation tube 109, which serves to rotate the arm tube 2.

Particularly, the rotation tube 109 is disposed on the outside diameter of the cylinder 100 and the cylinder 100 is attached to the rotation tube 109 so as to rotate together with the rotation tube 109. The mount assembly 1a includes a base plate 111 and a cover plate 112 mounted thereon. The cover plate 112 and the base plate 111 are affixed to one another by screws which pass through holes in the corners that mount the mount assembly 1a to the structure of a vessel. The cover plate 112 is provided with a central bore with a counter bore that receives rotation tube bearing 110, in which the rotation tube 109 is disposed. The rotation tube bearing 110 has a shoulder that abuts the counterbore to retain and locate the rotation tube bearing 110 in the cover plate 112. The rotation tube bearing 110 is preferably made of Polyoxymethylene (POM). The rotation tube 109 is affixed to a mounting tube 201 of the arm tube 2 and is preferably mechanically affixed thereto by a weld. In this way a rotation of the rotation tube 109, rotates the arm tube 2 therewith so that the outrigger pole 3 can be deployed.

The structure for driving a rotation of the rotation tube 109 is provided by a pinion or pinion gear 301 that is driven by hydraulically actuated racks 302 that are disposed on opposite sides of the pinion gear 301. The pinion gear 301 has tabs 310 that are directed radially inwards. The rotation tube 109 has corresponding slots formed therein, which allow the tabs 310 to pass through the rotation tube 109 and allow the tabs 310 to drive a rotation of the rotation tube 109. The tabs 310 continue radially past the rotation tube 109 and have a free end that is provided with a radius that corresponds to the outside diameter of the support ring 107 so as to positively position the support ring 107. The pinion gear 301 is provided with radial holes for respective set screws 108, which are received in threaded holes of the support ring 107. The rotation tube 109 has corresponding clearance holes to allow the set screws 108 to pass through the rotation tube to engage the threaded holes in the support ring 107. The end of the rotation tube bearing 110 abuts the pinion gear 301 and provides an axial bearing surface for the pinion gear 301. The base plate 111 is provided with a pinion gear bearing 303, which serves as an axial bearing surface on an opposite side of the pinion gear 301. An inside diameter of the pinion gear bearing 303 serves as a radial bearing surface for the support ring 107 as the support ring 107 rotates with the rotation tube 109. The pinion gear bearing 303 is also preferably made of Polyoxymethylene (POM).

Each of the racks 302 has a longitudinally extending rack cylinder 302c formed therein. The rack cylinders 302c each have bleeder valves 302bv for bleeding the hydraulic lines. The rack cylinder 302c receives a rack piston 304 that has a conduit formed therein for hydraulic fluid and a longitudinal end of the conduit is open to allow the conduit to provide hydraulic fluid into the rack cylinder 302c to displace the corresponding rack 302. The outside diameter of the rack piston 304 has a pair of grooves for ring seals 309 that seal the rack piston 304 with respect to the rack cylinder 302c. The rack piston 304 has a mounting end with a threaded stud 304s that passes through a sidewall of the base plate 111 and receives a nut 305 that mounts the rack piston to the base plate 111 and secures the position of the rack piston 304 when the rack 302 is actuated by the hydraulic fluid. The base plate 111 has openings in a bottom surface thereof to accommodate a hydraulic fitting 306 for a hydraulic line. The hydraulic fitting 306 is disposed on a circumference of the rack piston 304 and is fluidically connected to the conduit to supply the hydraulic fluid to the conduit and thus displace the rack 302 and rotate the pinion gear 301. Each of the racks 302 is provided with longitudinally extending rack channel 302ch. The side of rack channel 302ch of the rack 302 that is adjacent the side wall of the base plate 111 is provided with a rack slot 302s extending longitudinally on the rack 302. The side wall of the base plate 111 has an aperture that receives a screw that which mounts a guide sleeve 307 that is accommodated in the rack slot 302s for guiding the rack 302 during the movement of the rack 302. The guide sleeve 307 and the rack slot 302s also serve to limit the travel of the rack 302 and prevent the rack 302 from being pushed off of the rack piston 304. The guide sleeve 307 is retained on the screw by a nut 308. The rack channel 302ch is wide enough to accommodate the nut 308 therein.

A multi piece cylindrical cover 400 is mounted to the cover plate 112 by circumferentially distributed machine screws 401. The cylindrical cover 400 has an inside diameter that corresponds to an outside diameter of the rotation tube bearing 110 and serves to further support the rotation tube bearing 110, which is subject to considerable loads due to the length of the outrigger poles 3 and the wave action acting on the vessel. The cylindrical cover 400 is also provided with a passageway for a cable that is connected to a sensor that detects the lift angle of the outrigger arm tube 2, which will be further discussed hereinafter.

The mounting tube 201 is provided with a radially extending flange 500. The flange 500 has a cylindrical portion 501, which has bore 502 that receives a position indicator wheel 504 therein. The cylindrical portion 501 has a receptacle for receiving a Hall-effect sensor 503, which remains fixed relative to the position indicator wheel 504 and detects a rotational angle of the position indicator wheel 504 so that the angle of the arm tube 2 can be determined and the angle set as selected by the operator. To this end, the position indicator wheel 504 is provided with an insert 505 that is provided with axially extending rows of three apertures, where each row is radially spaced 15° from the adjacent row. Five rows are provided and cover 15° increments from 0 to 75°.

The Hall-effect sensor 503 is connected to a controller 600 by hard wiring for providing the positional information to the controller 600. However, it is possible that the communication connection to the controller 600 be wireless. It is within the scope of the invention that angular intervals and the range of rotation can be varied as desired. A first row of apertures corresponds to an 0° position of the arm tube 2 and has a corresponding pattern of magnet(s) 506 disposed in the apertures 505a formed insert 505. Each subsequent row of apertures has a different respective pattern of magnet(s) 506, which can be distinguished by position and or number of the magnets 506 in the respective row. The sensor 503 recognizes the pattern corresponding to the selected angle on the controller 600 and controls the lifting cylinder 100 to set the arm tube 2 at the desired/selected angle.

The arm tube 2 has an end thereof with an arm tube mount 202 that is cylindrical for mating to the position indicator wheel 504. The arm tube mount 202 and position indicator wheel 504 are rotationally affixed to one another by a spline connection 203. A mushroom shaped cap 506 is provided on an opposite side of the position indicator wheel 504 and sandwiches the position indicator wheel 504 with the arm tube mount 202. The position indictor wheel 504 includes a central bore that receives a spindle of the cap 506 and is clamped together by a mechanical fastener 507 that is received in a female threaded hole of the spindle. The bore 502 has a shoulder on one end which serves as a seat for a bearing 508 for the position indicator wheel 504. A second bearing 509 is provided on the other axial end of the bore 502. The bearings 508 and 509 are preferably also made out of POM.

The spline connection 203 serves to rotate the position indicator wheel 504 when the lifting link 102 is actuated. Accordingly, the center axis H of the position indicator wheel 504 defines the axis of rotation H for the arm tube 2 about which the arm tube 2 is rotated when the lifting link 102 is actuated.

In the above-given description the disclosure pertains to one side (port or starboard of a vessel), of the arm tube assembly, however the description applies to the same for both sides of the vessel.

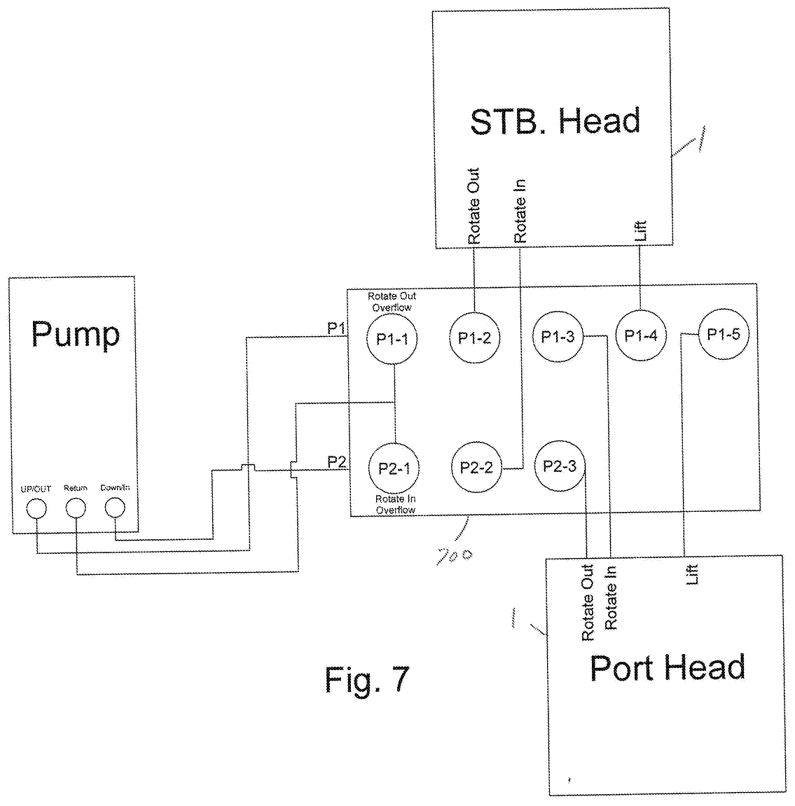

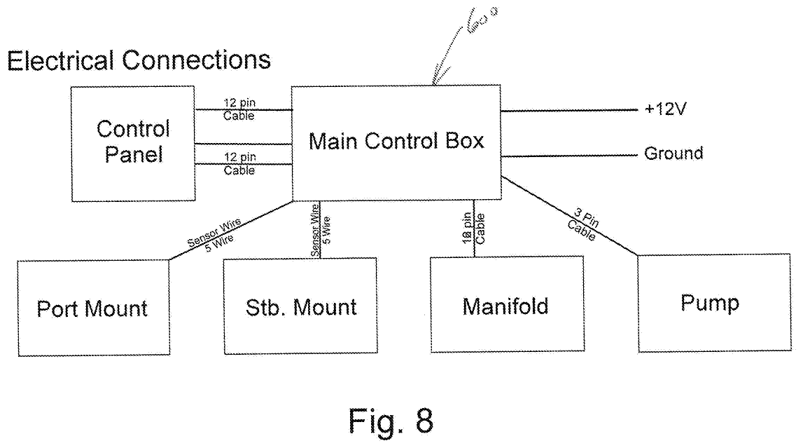

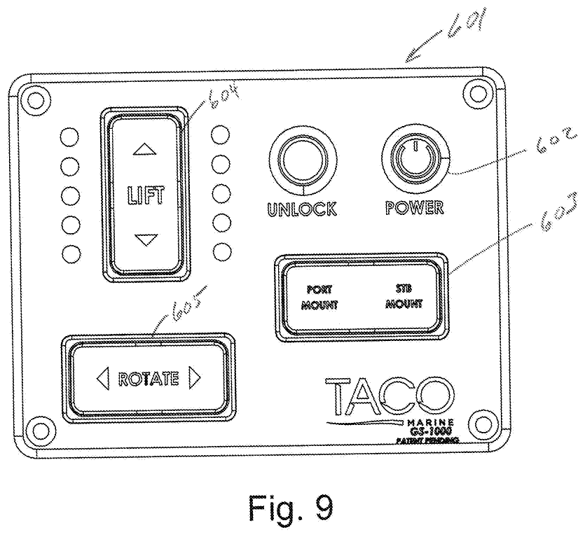

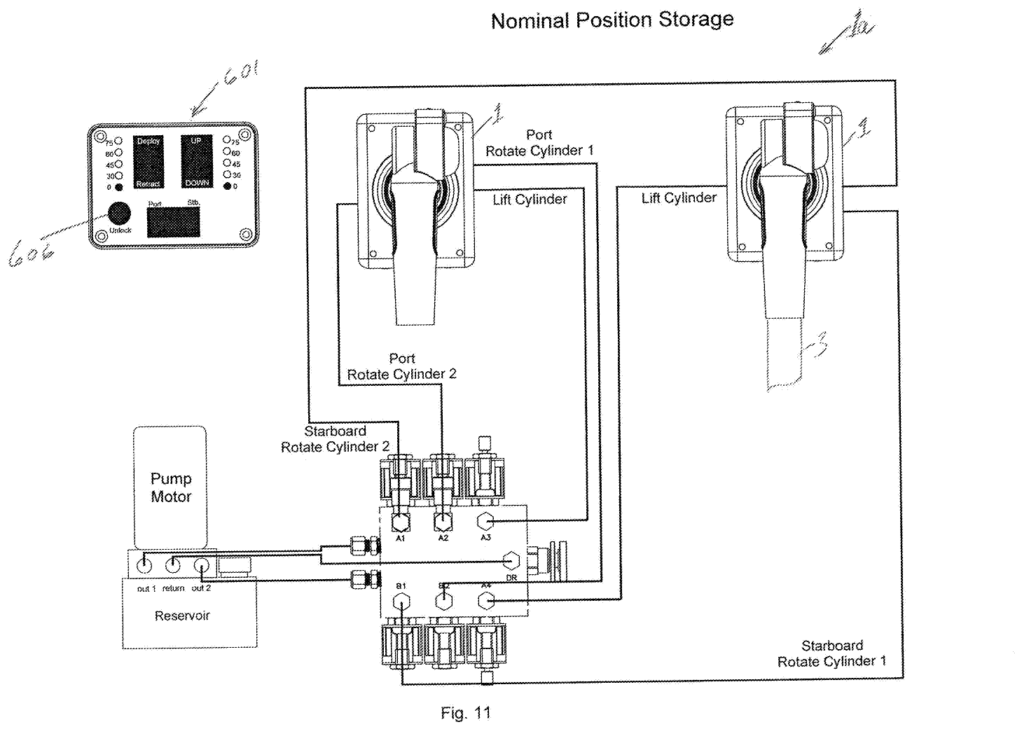

The operation and fluid flow of the outrigger mount will be discussed with respect to FIGS. 7-9 and FIGS. 11-13. A user interface 601 of the controller 600 is shown in FIGS. 9 and 11-13, with FIGS. 11-13 having a slightly different layout of the control elements. As seen the user interface 601 has power switch 602. A selector switch 603 is provided to select port or starboard mount. A lift switch 604 is provided and has two columns of LED indicators, one column for port and one for starboard, where each LED represents an selectable lift angle for the tube arm 2, shown as 0°, 30°, 45°, 60°, and 75° in FIGS. 11-13. Accordingly, each side can be set independent of one another. A rotation/rotate switch 605 and an “unlock” switch 606 are provided. The rotation/rotate switch 605 controls the rotation of the mounts, where the rotation switch 605 will only move the mounts when the “unlock” switch 606 is simultaneously operated. This means that a user has to purposefully operate the switches 605 and 606 so as to prevent an accidental rotation of the arm tube 2, which could unintentionally knock a person overboard, if an object were to inadvertently actuate the rotation switch 605.

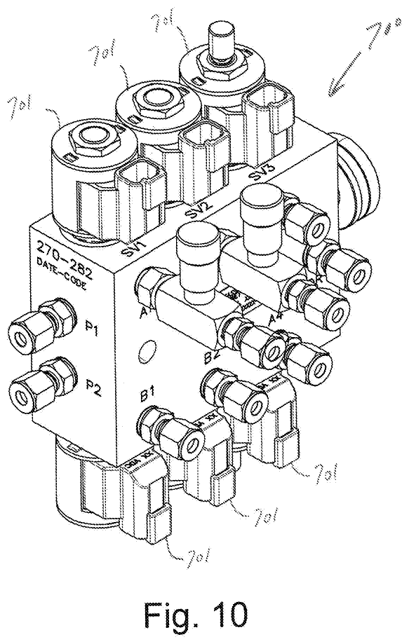

As seen in FIGS. 7, 8, and 10 a manifold 700 is provided to control fluid flow and movements of the system based upon user direction on the user interface 601. The manifold 700 is provided with locking valves 701 that are plumbed to the mounts and the hydraulic cylinders provided therein. The valves 701 lock the mount into place when the switches are not being operated. Therefore, the locking valves 701 prevent any movement (drifting) of the arm tube 2 when the outrigger poles 3 are in use.

The manifold includes two of the locking valves 701 for rotation on each side of the vessel and a lifting valve 701 for each side of the vessel. One inlet is provided in the manifold 700 for each side of the vessel from the pump and a common return is provided for the return to the pump reservoir. All the valves and the pump are electrically connected to 12v power and to the controller 600.

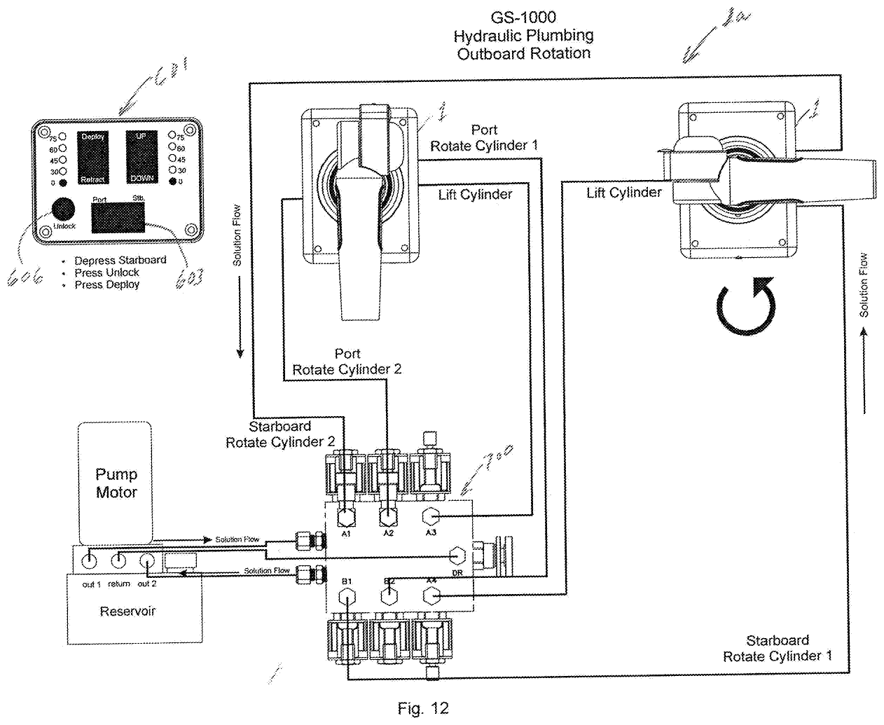

Operation of the device is as follows and applies for port and starboard mounts. Firstly, the user selects which mount 1 is to be operated port/starboard with the selector switch 603. Once the vessel side is selected the selected side is operationally controlled by the user interface 601. With respect to FIG. 12, starboard has been selected.

The rotate switch 605 is actuated in the selected direction (outboard in FIG. 12) and the unlock switch 606 is also engaged, the pump is actuated and the corresponding valve for the selected direction is opened and hydraulic fluid forces the corresponding rack cylinder 302c to rotate the pinion 301 and thus the rotation tube 109 in the selected direction (outboard/inboard). The valve for opposing rack cylinder 302c is moved to a return flow position and the rotation of the pinion forces the opposing rack cylinder 302c against the rack piston 304 compressing the volume and forcing the hydraulic fluid back to the pump reservoir through the corresponding valve. Once the desired rotation is achieved, the rotate switch 605 is released by the user and the valves are moved into the locked position. Accordingly, hydraulic fluid remains on both rack cylinders 302c and the rotation of the mount 1 is “locked” by the hydraulic pressure in the lines on both sides of the pinion.

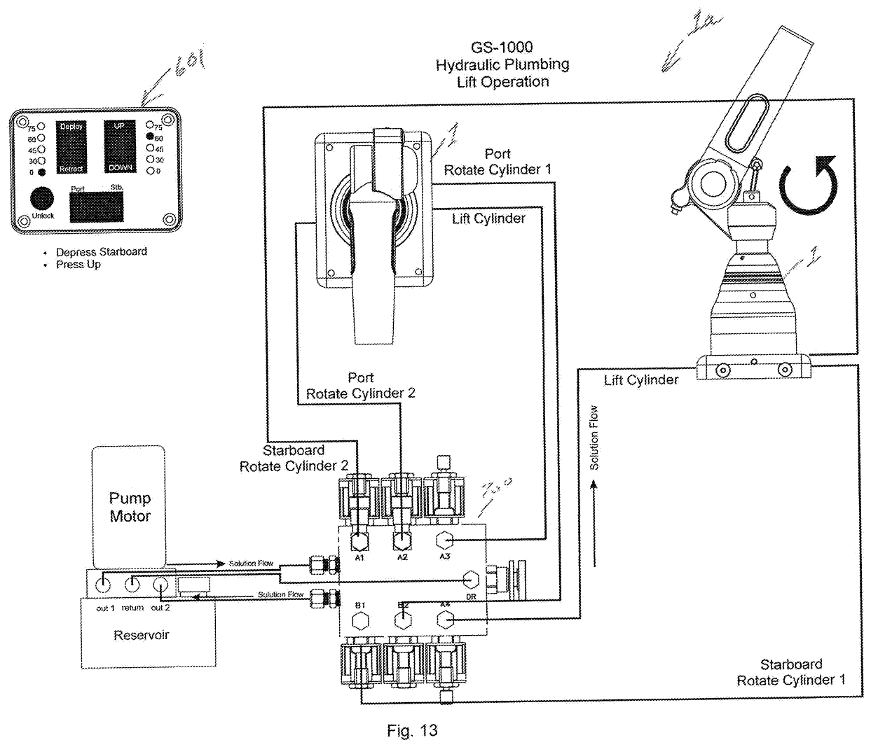

The lifting operation for the starboard mount is discussed with respect to FIG. 13. The selector switch 603 is set to starboard side and then the lift switch 604 is indexed until the desired angle LED is reached. The controller determines the according magnet pattern of the magnets for the Hall-effect sensor 503 to detect. The pump is started and the starboard lift valve is opened and the lifting cylinder 100 is raised, which raises the arm tube 2 and rotates the position indicator wheel 504. Once the Hall-effect sensor 503 detects the corresponding magnet pattern for the selected angle, the valve is closed and the pump stopped. Thus, the arm tube 2 is inclined at the selected angle. When the arm tube is desired to be brought back to the 0° position (or a lower position in which the arm tube 2 is at) the user selects the angle and the valve is placed into a return flow position and gravity assisted by the return spring 105 lowers the arm tube 2 until the sensor 503 detects the appropriate magnet pattern, at which point the valve is moved into the locked position. The valves for lifting are provided with a manual actuator that moves the valves into a return flow position back to the pump reservoir in the event that the valve fails. Since the arm tube 2 is lowered by gravity and the return spring 105, this allows the arm tube 2 to be lowered in the event of valve failure.

The controller may also be programmed so that actuation of the rotate and lift switches simultaneously for five seconds causes arm tubes 2 to rotate inboard and to lower to 0°. Such provision is to quickly return the outriggers poles 3 to move into a position for low clearance bridges etc. when/if it is overlooked by the user to move the arms 2 to the home position.

I claim:

1. An outrigger mount assembly comprising:
an arm tube configured for receiving and holding an outrigger pole, said arm tube being rotationally displaceable in a lifting direction and in a lateral direction;
a hydraulic lifting cylinder with a lifting piston operationally connected to said arm tube for rotating said arm tube in the lifting direction;
a rotation tube operationally connected to said arm tube;
a pinion affixed to said rotation tube opposite said arm tube;
a pair of opposing hydraulically driven rack gears for driving said pinion and rotating said arm tube via said rotation tube;
an electronic controller with a user interface for controlling said rack gears and said hydraulic lifting piston.

2. The mount assembly according to claim 1, further comprising a rotation tube bearing, said rotation tube being disposed in said rotation tube bearing and said lifting cylinder being disposed inside of said rotation tube.

3. The mount assembly according to claim 1, wherein said arm tube has a mount tube to affix said arm tube to said rotation tube, said mount tube having a radially extending flange with a cylindrical portion defining a lifting axis about which said arm tube is rotated when displaced in the lifting direction.

4. The mount assembly according to claim 3, further comprising a position indicator wheel disposed in said cylindrical portion, said position indicator wheel being affixed to said arm tube for rotation with said arm tube when said arm tube is rotated in the lifting direction.

5. The mount assembly according to claim 4, further comprising a Hall-effect sensor, said position indicator wheel having an insert with respective magnet patterns of magnets for each selectable angular position of said arm tube, said sensor being disposed for detecting a magnet pattern of a user selected angular position of said arm tube and controlling the lifting piston.

6. The mount assembly according to claim 1, wherein said rack gears each have a respective rack cylinder formed therein that extend in a longitudinal direction thereof.

7. The mount assembly according to claim 6, wherein each said rack cylinder has a corresponding tubular rack piston disposed therein, said rack piston has a conduit formed therein, said conduit opening into said rack cylinder to supply hydraulic fluid to said rack cylinder to actuate said rack cylinder and rotate said pinion.

8. The mount assembly according to claim 7, further comprising a pump fluidically connected to each said rack piston for supplying hydraulic fluid to each said rack piston.

9. A method of operating an outrigger mount with an arm tube for deploying an outrigger pole disposed in said arm tube, comprising:
providing a mount with an arm tube being rotationally displaceable in a lifting direction and in a lateral direction of a vessel;
providing a user interface for user control of the mount;
hydraulically raising a lifting piston connected to the arm tube for rotating the arm tube in the lifting direction according to a user selected angular position of the arm tube on the user interface;
hydraulically rotating a rotation tube operationally connected to the arm tube according to user actuation of a rotation switch by controlling a pair of opposing hydraulically driven rack gears rotating a pinion operatively connected to the rotation tube.
